(19) United States
(12) Patent Application Publication
(10) Pub. No.: US 2012/0033840 A1
(43) Pub. Date: Feb. 9, 2012

(54) HEARING INSTRUMENT WITH AN INTEGRAL INJECTION-MOLDING CASING

(75) Inventor: VOLKER GOLY, ERLANGEN (DE)

(73) Assignee: SIEMENS MEDICAL INSTRUMENTS PTE. LTD., SINGAPORE (SG)

(21) Appl. No.: 13/196,944

(22) Filed: Aug. 3, 2011

(30) Foreign Application Priority Data
Aug. 3, 2010 (DE) 10 2010 033 140.6

(51) Int. Cl. H04R 25/00

(52) U.S. Cl. 381/322

(57) ABSTRACT

A hearing instrument has an integral injection-molding casing. The hearing instrument fixes the internal components in an integral casing that is simple in design, production, and assembly; requires few components; and is easy to handle. Accordingly the hearing instrument contains an integral casing and a frame arranged within the casing. The casing has an assembly opening through which the frame is pushed into the casing. Additionally, the casing has a fixation opening oriented perpendicular to the insertion direction, which fixation opening interacts with a fixation device arranged on the frame in order to fix the frame in the casing. This provides a simple fixation mechanism. The fixation opening can be applied as a bore after the production of the casing, and so the casing has no undercuts and can therefore be produced in an injection-molding method. The fixation device can be embodied as a bolt. The bolt can be integrally molded onto the frame. The bolt can be inserted into the fixation opening by a spring force. In one embodiment, a microphone to be assembled after the frame has been inserted into the casing serves as a bolt.

### CROSS-REFERENCE TO RELATED APPLICATION

This application claims the priority, under 35 U.S.C. §119, of German application DE 10 2010 033 140.6, filed Aug. 3, 2010; the prior application is herewith incorporated by reference in its entirety.

### BACKGROUND OF THE INVENTION

### Field of the Invention

The invention relates to a hearing instrument with an integral injection-molding casing.

By way of example, hearing instruments can be configured as hearing aids. A hearing aid serves to supply a person, who has damaged hearing, with acoustic signals from the surroundings, which have been processed and amplified for compensating for or for treating the respective damage to the hearing. In principle, it consists of one or more input transducers, a signal-processing apparatus, an amplifier apparatus, and an output transducer. The input transducer generally is a sound receiver, e.g. a microphone, and/or an electromagnetic receiver, e.g. an induction coil. The output-signal generator is generally implemented as an electroacoustic transducer, e.g. a miniaturized loudspeaker, or as an electromechanical transducer, e.g. a bone-conduction receiver. It is also referred to as a receiver. The output-signal generator produces output signals that are guided to the ear of the patient and should generate a sense of hearing in the patient. The amplifier is generally integrated into the signal-processing apparatus. The hearing aid is supplied with current by a battery that is integrated into the hearing-aid casing. The essential components of a hearing aid are generally arranged on a printed circuit board as an interconnect device or connected thereto.

Furthermore, hearing instruments could also serve as hearing aids that serve to compensate for a reduced hearing, usually referred to as hearing loss; they can also be embodied as so-called tinnitus maskers. Tinnitus maskers are used for treating tinnitus patients. They generate acoustic output signals that can contribute to reducing bothersome tinnitus or other ear noises affecting the perception and are dependent on the respective hearing impairment and, depending on operating principle, on the surrounding noise as well.

In the following text, the term hearing instrument should be understood to mean hearing aids, tinnitus maskers, and other such instruments.

Hearing instruments often have two-part or multi-part casings that are produced in an injection-molding process. The casings are usually separated along the longitudinal extent thereof. The multi-part casing configuration allows a simple assembly of the interior components. The components can initially be assembled in a first casing part before a further casing part is placed and affixed thereon for sealing and completing the casing. The multi-part casing design moreover ensures larger freedom in design for the casing mold. Although injection-molding methods cannot form undercuts as a matter of principle, undercuts in the overall casing can nevertheless be brought about by virtue of the fact that there is a suitable subdivision into individual casing parts and the indentations that form the undercuts are provided in the individual casing parts (but not as undercuts therein).

A disadvantage of subdivided casings is the increased logistic part complexity because a larger number of casing parts and assembly elements are required. Moreover, the casing separation lines (casing gaps) are susceptible to the ingress of moisture and dirt. Hence, it is of interest to reduce the total length of casing separation lines. This can be achieved by integral casings that merely have as few and as small casing openings as possible. In an integral casing, all interior components of the hearing instrument, in particular the receiver, signal-processing electronics and battery, have to be introduced into the casing through a casing opening, which should be provided for assembly purposes but is as small as possible. By way of example, the interior components including the battery can be introduced through the battery opening in the casing. After the assembly, the battery opening is maintained for inserting and replacing the battery and consequently is required in any case.

A problem in such an assembly consists of fixing the components within the casing. The interior of the casing is no longer readily accessible after the components have been introduced in order, for example, to be able to insert fixation pins or fixation screws. Moreover, as outlined above, it is not possible to provide undercuts in the casing, which undercuts could serve for the fixation. However, fixing is indispensible so that the components do not lie loosely in the casing and are able to move therein, which could cause bothersome noises. Moreover, the components should be prevented from being able to slide out of the casing when the battery compartment is opened for the purpose of replacing the battery.

U.S. Pat. No. 6,959,097 B1 discloses a hearing aid, the casing of which is based on a structure with two casing parts. The interior components are assembled on a plate, referred to as front plate, which forms the first casing part. The second casing part is put over the components and connected to the front plate, for example by screws or a snap-fit connection.

International patent disclosure WO 2006/067133 A1 discloses a hearing aid with a casing into which the interior components preassembled on a frame are inserted through the battery opening. The battery compartment has a battery-compartment cover that can pivot. A pin passes through casing, frame, and battery-compartment cover and serves both as pivot axis for the battery-compartment cover and also for fixing the frame.

Published, European patent application EP 0 288 822 A1 discloses a hearing aid that has both an external casing and an interior casing part, referred to there as a module shell. The interior casing part contains the interior components of the hearing aid. The external casing is fitted to the shape of an auditory canal into which the hearing aid should be inserted.

### SUMMARY OF THE INVENTION

It is accordingly an object of the invention to provide a hearing instrument with an integral injection-molding casing which overcome the above-mentioned disadvantages of the prior art methods and devices of this general type.

The object of the invention consists of specifying a fixation for the interior components of a hearing instrument in an integral casing, which is simple in design, production, and assembly; requires few components; and is easy to handle.

According to a basic idea of the invention, a hearing instrument contains a casing and a frame arranged within the casing, wherein the casing has an integral design and surrounds the frame in five spatial directions. In a further spatial direction, the casing has an assembly opening that is dimensioned such that the frame can be pushed into the casing through the opening. In addition to the assembly opening, the casing has a fixation opening in a spatial direction perpendicular to the spatial direction of the assembly opening, which fixation opening interacts with a fixation device, which is arranged on the frame, such that the frame is fixed against sliding out of the casing. This provides a simple fixation mechanism for fixing the frame in the casing. If the fixation opening is applied after the production of the casing, for example as a bore, this results in the option of producing the casing in an injection-molding method because such a fixation mechanism does not require undercuts in the casing, which would be unable to be produced in the injection-molding method. The bore can also be produced by a bar from the outside in the injection-molding tool. The opening subsequently has to be resealed in any case, for example by a microphone cover.

An advantageous development provides for the fixation device to contain a bolt, which is introduced into the fixation opening. This results in a structurally particularly simple form of fixation.

A further advantageous development provides for the bolt to be integrally molded onto the frame. The integral mold reduces the assembly complexity in respect of logistic requirements because no additional bolt is required and hence the number of components is reduced. Moreover, it also reduces the assembly complexity in respect of the actual assembly process because the handling of a separate additional component is dispensed with.

A further advantageous development provides for the bolt to be reversibly introduced into the fixation opening and kept therein by a spring force. This results in a further reduction in the assembly complexity and a simplification in the assembly complexity because the fixation is produced automatically as a result of the spring force when the frame is inserted into the casing.

A further advantageous development provides for the bolt, using an elastic material, to be molded onto the frame such that, as a result of this, a spring force, directed in the direction of the fixation opening, is applied thereon. To this end, the bolt can preferably be arranged on an elastic arm. As a result, it is possible to dispense with additional separate elastic device components, as a result of which there is a further reduction in the logistical and assembly complexity.

A further advantageous development provides for provision to be made for an elastic device that applies a spring force, directed in the direction of the fixation opening, onto the entire frame. As a result, depending on requirements, this provides securing in addition, or as an alternative, to a bolt with the spring force applied thereon. If a spring force is applied to the entire frame, this secures not only the fixation but the entire frame against movement within the casing. Movements of the frame can cause bothersome noises, e.g. a rattle, which are effectively cut out in a simple fashion by the application of a spring force.

A further advantageous development provides for the bolt to be embodied as a barb. The fixation opening is fitted to the bolt such that, as a result of the mutual engagement with the fixation opening, a force directed into the fixation opening is applied to the bolt when the frame moves in the direction of sliding out of the casing. Thus it is thereby automatically moved into the fixation opening. The embodiment as a barb further secures the fixation against undesired release. Moreover, there are additional options for securing the fixation by a spring force. On the one hand, the barb can, as before, be secured by a spring force directed in the direction of the fixation opening. However, on the other hand, loading the frame in the direction of the assembly opening, i.e. in the direction out of the casing, also contributes to securing the fixation. As a result, this allows embodiments with an entirely different embodiment and effect of the elastic device component; for example, the elastic device component can be provided in the casing on the side opposite to the assembly opening.

A further advantageous development provides for the fixation opening to be additionally embodied as a microphone opening and the fixation device to be additionally embodied as a microphone receptacle. Since a microphone opening is required in any case, this can reduce the number of casing openings. This further decreases the susceptibility to the ingress of dirt and moisture.

A further advantageous development provides for the frame to be fixed as a result of a mutual engagement between a microphone, inserted into the microphone receptacle, and the microphone opening. The microphone thus so to speak forms the bolt by which the frame is fixed in the casing. It can be provided as an alternative to a bolt or in addition thereto. Since a microphone is required in any case, at least in a hearing aid, this can bring about further securing without further additional component complexity. If a bolt in addition to the microphone is dispensed with, this can bring about a further simplification of the design and a reduction in the design components and, optionally, a reduction in the number of components as well.

A further advantageous development provides for the assembly opening to be designed to serve as a battery opening as well. Since a battery opening is generally required in any case, this results in a further reduction in the number of casing openings. This further reduces the susceptibility to the ingress of dirt and moisture.

A further basic idea of the invention consists of designing a casing for a hearing instrument such that it can be used in a hearing instrument with the features explained above.

A further basic idea of the invention consists of designing a frame for a hearing instrument such that it can be used in a hearing instrument with the features explained above.

An advantageous development provides for internal components of a signal-processing apparatus of a hearing instrument to be mounted on the frame. This allows a simple and easy preassembly of components onto the frame, without there being impediments by the casing in the process.

Other features which are considered as characteristic for the invention are set forth in the appended claims.

Although the invention is illustrated and described herein as embodied in a hearing instrument with an integral injection-molding casing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view of a hearing aid with an elastic bolt according to the invention;

FIG. 2 is a diagrammatic, sectional view of the hearing aid with a spring force applied to a frame;

FIG. 3 is a diagrammatic, sectional view of the hearing aid with a bolt embodied as a barb; and

FIG. 4 is a diagrammatic, sectional view of the hearing aid with a microphone acting as the bolt.

### DETAILED DESCRIPTION OF THE INVENTION

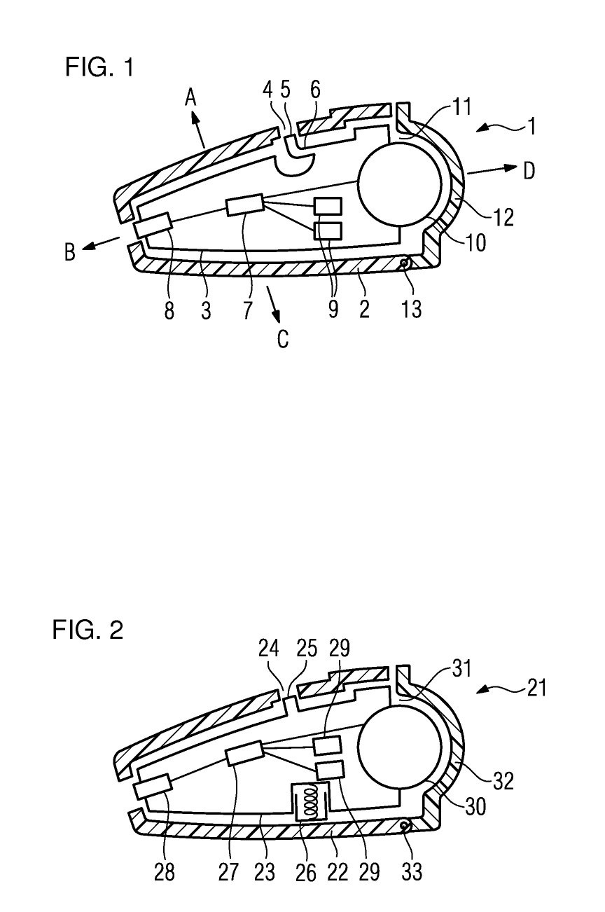

Referring now to the figures of the drawing in detail and first, particularly, to FIG. 1 thereof, there is shown schematically a cross section of a hearing aid 1 with an elastically mounted bolt 5. The hearing aid 1 includes a casing 2 and a frame 3 arranged in the casing 2. Signal-processing components of the hearing aid 1 are arranged on the frame 3, specifically a signal-processing apparatus 7, a receiver 8 and microphones 9. Furthermore, a battery 10 as an energy supply for the signal-processing components is arranged in the casing 2 and electrically connected to the signal-processing apparatus 7 or the frame 3.

An arm 6 is molded onto the frame 3 and, arranged on the arm, the bolt 5 is molded on. The arm 6 consists of an elastic material, which can be the same material as used in the frame 3 or can be molded on by a two-component production method. As illustrated in FIG. 1, the arm 6 is shaped such that it makes the bolt 5 engage with the fixation opening 4 of the casing 2, i.e. such that the bolt 5 is introduced into the fixation opening 4.

In the casing 2, the fixation opening 4 is arranged in a spatial direction that is indicated by an arrow denoted by the letter A in the figure for illustrative purposes. Further arrows indicate further spatial directions B, C, D. An assembly opening 11 is provided in the casing 2 in spatial direction D, through which the equipped or preassembled frame 3 can be inserted into or pulled out of the casing 2. The assembly opening 11 at the same time serves as a battery-compartment opening, into which the battery 10 is inserted. It is sealed by a battery-compartment cover 12. The battery-compartment cover 12 is mounted in the casing 2 such that it can pivot about an axis 13 and can be opened by pivoting. The battery-compartment cover 12 needs to be opened, on the one hand, for inserting or replacing the battery 10. On the other hand, the frame 3 can be inserted in spatial direction B or pulled out in spatial direction D when the battery compartment is open.

As seen from the assembly opening 11, the casing 2 has no undercuts. Hence the casing 2 can be produced in a simple fashion, for example in a conventional injection-molding method. The fixation opening 4 could in this case be added subsequently, for example as a bore. The fixation opening 4 is provided to fix the frame 3 in the casing 2 in spatial direction D against being pulled out or against unwanted sliding out. To this end, the fixation opening 4 and the bolt 5 mutually engage. The figure shows that the bolt 5 prevents a movement of the frame 3 in spatial direction D. In order nevertheless to be able to remove the frame 3, or in order to be able to insert it into the casing 2, the bolt 5 can be pressed toward the frame 3 and away from the fixation opening 4, i.e. in spatial direction C, as a result of its elastic mount. In the process, the bolt is pressed counter to the spring force of the elastic arm 6 and the latter presses the bolt 5 back in spatial direction A as soon as there is no more action from external forces. Hence, when the frame 3 is inserted, the bolt 5 is automatically pressed in the direction of the fixation opening 4 and therefore automatically inserted into the latter. Thus, the fixation is generated automatically when the frame 3 is inserted into the casing 2.

It is possible to see that already one fixation opening 4 suffices to this end and no additional fixation components are required. Moreover, depending on the embodiment of the bolt 5 and the fixation opening 4, the fixation can be released without special tools for the purpose of removing the frame 3 from the casing 2 by simply pressing the bolt 5 through the fixation opening 4.

FIG. 2 schematically illustrates a cross section of a hearing aid 21 with a casing 22 and a frame 23 arranged therein, on which a fixing spring force acts in its entirety. A signal-processing apparatus 27, a receiver 28, and microphones 29 are arranged on the frame 23. A battery 30 is moreover arranged in the casing 22, which battery is electrically connected to the frame 23 or the signal-processing components. It moreover has an assembly opening 31, which, as explained above, is simultaneously configured as a battery-compartment opening. A battery-compartment cover 32 is mounted with an axis 33 in the casing 22 such that it can pivot and at the same time seals the battery compartment and the assembly opening 31.

Furthermore, the casing 22 has a fixation opening 24, which serves to fix the frame 23 in the casing 22. To this end, the bolt 25 and the fixation opening 24 are in mutual engagement. The entire frame 23 including the bolt 25 is pressed in the direction of the fixation opening 24 by a spring mechanism 26. As a result, the fixation is automatically produced and secured because the bolt 25 can only leave the fixation opening 24 by applying an external force against the spring force of the spring mechanism 26. By introducing the bolt 25 into the fixation opening 24, the fixation is thus produced automatically by the spring mechanism 26 when the frame 23 is inserted into the casing 22. In order to remove the frame 23, the frame 23 with the bolt 25 can, as explained above, be pressed against the spring force out of the fixation opening 24 and into the interior of the casing 22 in order to release the fixation in that way.

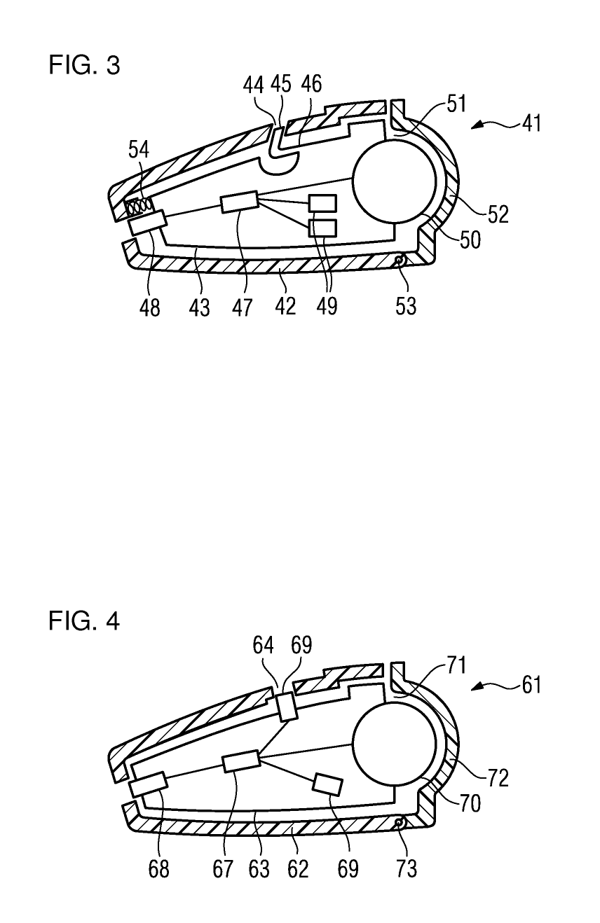

FIG. 3 schematically illustrates a cross section of a hearing instrument 41 with a bolt 45 embodied as a barb. As explained above, the hearing instrument has a casing 42 with a battery-compartment cover 52 that can be pivoted about an axis 53. A frame 43 with the signal-processing components of receiver 48, signal-processing apparatus 47, microphones 49, and an attached battery 50 is arranged in the casing 42.

The casing has a fixation opening 44 with an angled profile, fitted to the shape of the bolt 45. It is possible to identify that the angled profile and the corresponding bolt 45 molded at an angle bring about an effect as a barb to the extent that the bolt is forced deeper into the fixation opening 44 as a result of movement of the frame 43 in the direction of the assembly opening 51. The bolt 45 is arranged on an arm 46 and molded onto the frame 43 via the latter. It can have an integral design and be made out of the same material or it can be made from another material and molded on in a two-component design. More particularly, the arm 46 can consist of an elastic material, and so the bolt 45 is guided into the fixation opening 44 or kept therein as a result of the spring force of the elastic arm 46. In order to release the fixation, the bolt 45 can be pressed out of the fixation opening 44 and into the interior of the casing 42 counter to the spring force of the elastic arm 46. However, the arm 46 may also consist of non-elastic material or the bolt 45 need not be arranged on an arm because the embodiment as a barb in any case produces a secure fixation. If the arm 46 is non-elastic, in order to release the fixation, it is merely the entire frame 43 instead of the arm that has to be able to be moved such that the bolt 45 is pushed out of the fixation opening 44 and into the interior of the casing 42. To this end the frame 43 must have enough freedom of movement in the corresponding direction within the casing 42.

The fixation of the frame 43 in the casing 42 is in any case ensured as a result of embodying the bolt 45 as a barb. To this end provision is made for an elastic component, which is embodied as a spring mechanism 54. The latter pushes the frame 43 in the direction of the assembly opening 51. As a result of the mutual engagement as explained above between bolt 45, embodied as a barb, and fixation opening 44, the bolt 45 is pressed into the fixation opening 44 as a result of this spring, and hence a secure fixation is ensured. Thus, in order to be able to remove the frame 43 from the casing, a force must initially be applied to overcome the spring force of the spring mechanism 54 and to push the frame 43 further into the casing 42 until the bolt 45 is released.

FIG. 4 illustrates a hearing aid 61 with casing 62 and frame 63. As explained above, the casing contains a battery-compartment cover 72, mounted about an axis 73, and an assembly opening 71. A fixation opening 64 serves to fix the frame 63 in the casing 62. A battery 70 is arranged within the casing and it is electrically connected to the frame or the components arranged thereon.

A signal-processing apparatus 67, a receiver 68, and a microphone 69 are arranged on the frame 63. The microphone 69 is in mutual engagement with the fixation opening 64. The microphone is assembled on the frame 63 or disassembled therefrom through the fixation opening 64. The mutual engagement between microphone 69 and fixation opening 64, which ensures the fixation of the frame 63 in the casing 62, is created during the assembly of the microphone 69. Thus, during assembly, the frame 63 is pushed into the casing 62 through the assembly opening 71 and the microphone 69 is subsequently assembled on the frame through the fixation opening 64, during which the fixation is produced. In order to remove the frame 63 from the casing 62, the microphone 69 is first removed through the fixation opening 64 and the fixation is released in the process. The frame 63 can thereupon be removed through the assembly opening 71. To (dis)assemble the microphone 69 from the outside would pose particular requirements to the electrical link and connection; by way of example a particularly suitable plug-in connector could be provided for this case.

A basic idea of the invention can be summarized as follows: The invention relates to a hearing instrument with an integral injection-molding casing. The object of the invention consists of specifying a way of fixing the internal components of a hearing instrument in an integral casing that is simple in design and assembly, requires few components, and is easy to handle. According to the invention, a hearing instrument contains an integral casing 2, 22, 42, 62 and a frame 3, 23, 43, 63 arranged within the casing 2, 22, 42, 62. The casing 2, 22, 42, 62 has an assembly opening 11, 31, 51, 71 through which the frame 3, 23, 43, 63 is pushed into the casing 2, 22, 42, 62. Additionally, the casing 2, 22, 42, 62 has a fixation opening 4, 24, 44, 64 oriented perpendicular to the insertion direction, which fixation opening interacts with a fixation device arranged on the frame 3, 23, 43, 63 in order to fix the frame 3, 23, 43, 63 in the casing 2, 22, 42, 62. This provides a simple fixation mechanism; the fixation opening can be applied as a bore after the production of the casing, and so the casing has no undercuts and can therefore be produced in an injection-molding method. The fixation device can be embodied as a bolt. The bolt can be integrally molded onto the frame. The bolt can be inserted into the fixation opening 4, 24, 44, 64 by a spring force. In one embodiment, a microphone 69 to be assembled after the frame 63 has been inserted into the casing 62 serves as a bolt.

1. A hearing instrument, comprising:
a casing;
a frame disposed within said casing, said casing having an integral design and surrounding said frame in five spatial directions;
a fixation device disposed on said frame; and
said casing having in a further spatial direction an assembly opening formed therein dimensioned such that said frame can be pushed into said casing through said assembly opening, said casing further having a fixation opening formed therein in one of the spatial directions perpendicular to the further spatial direction of said assembly opening, said fixation opening interacting with said fixation device disposed on said frame, such that said frame is fixed against sliding out of said casing.

2. The hearing instrument according to claim 1, wherein said fixation device has a bolt, which is introduced into said fixation opening.

3. The hearing instrument according to claim 2, wherein said bolt is integrally molded onto said frame.

4. The hearing instrument according to claim 2, wherein said bolt is reversibly introduced into said fixation opening and kept therein by a spring force.

5. The hearing instrument according to claim 1, wherein said bolt is molded onto said frame using an elastic material, such that, as a result of this, a spring force, directed in a direction of said fixation opening, is applied thereon.

6. The hearing instrument according to claim 4, further comprising an elastic device that applies a spring force, directed in a direction of said fixation opening, onto said frame.

7. The hearing instrument according to claim 4, wherein said bolt is embodied as a barb, and in that said fixation opening is fitted to said bolt such that, as a result of a mutual engagement with said fixation opening, a force directed into said fixation opening is applied to said bolt when said frame moves in a direction of sliding out of said casing.

8. The hearing instrument according to claim 1, wherein said fixation opening is further embodied as a microphone opening and said fixation device is embodied as a microphone receptacle.

9. The hearing instrument according to claim 8, further comprising a microphone and said frame is fixed as a result of a mutual engagement between said microphone, inserted into said microphone receptacle, and said microphone opening.

10. The hearing instrument according to claim 1, wherein said assembly opening is configured to serve as a battery opening as well.

11. The hearing instrument according to claim 5, wherein said frame has an arm and said bolt is formed on said arm.

12. A casing for a hearing instrument having a frame and a fixation device disposed on the frame, the casing comprising:
a casing body for housing the frame disposed within said casing body, said casing body having an integral design and surrounding the frame in five spatial directions;
said casing body having in a further spatial direction an assembly opening formed therein dimensioned such that the frame can be pushed into said casing body through said assembly opening, said casing body further having a fixation opening formed therein in one of the spatial directions perpendicular to the further spatial direction of said assembly opening, said fixation opening interacting with the fixation device disposed on the frame, such that the frame is fixed against sliding out of said casing body.

13. A frame for a hearing instrument having a casing, the frame comprising:
a frame body disposed within the casing, the casing having an integral design and surrounding said frame body in five spatial directions;
a fixation device disposed on said frame body;
the casing having in a further spatial direction an assembly opening formed therein dimensioned such that said frame body can be pushed into the casing through the assembly opening, the casing further having a fixation opening formed therein in one of the spatial directions perpendicular to the further spatial direction of the assembly opening, the fixation opening interacting with said fixation device disposed on said frame body, such that said frame body is fixed against sliding out of the casing.

14. The frame according to claim 13, wherein said frame body mounts internal components of a signal-processing apparatus of the hearing instrument.
